(19) United States
(12) Patent Application Publication
(10) Pub. No.: US 2024/0013585 A1
(43) Pub. Date: Jan. 11, 2024

(54) VEHICLE COMMUNICATION SYSTEM, CONTROL UNIT, AND METHOD FOR ENABLING COMMUNICATION BETWEEN A MAIN CONTROLLER OF A HEAVY-DUTY VEHICLE AND ONE OR MORE ADD-ON MODULE(S)

(71) Applicant: Volvo Truck Corporation, Göteborg (SE)

(72) Inventors: Bo Strömberg, Västra Frölunda (SE); Joshua Shire, Göteborg (SE)

(21) Appl. No.: 18/346,348

(22) Filed: Jul. 3, 2023

(30) Foreign Application Priority Data
Jul. 7, 2022 (EP) 22183637.2

(51) Int. Cl. G07C 5/00

(52) U.S. Cl. CPC G07C 5/008

(57) ABSTRACT

A vehicle communication system for enabling communication between a main controller of a heavy-duty vehicle and one or more add-on module(s) arranged to be connected to the heavy-duty vehicle. The vehicle communication system comprises a logical network segment arranged for communication between each add-on module and the main controller thereby enabling each add-on module to communicate with the main controller over a separate logical network segment.

### RELATED APPLICATIONS

The present application claims priority to European Patent Application No. 22183637.2, filed on Jul. 7, 2022, and entitled “VEHICLE COMMUNICATION SYSTEM, CONTROL UNIT, AND METHOD FOR ENABLING COMMUNICATION BETWEEN A MAIN CONTROLLER OF A HEAVY-DUTY VEHICLE AND ONE OR MORE ADD-ON MODULE(S),” which is incorporated herein by reference in its entirety.

### TECHNICAL FIELD

The present disclosure relates generally to a vehicle communication system, a control unit, a method performed by the control unit and a heavy-duty vehicle. More particularly, the present disclosure relates to enabling communication between a main controller of a heavy-duty vehicle and one or more add-on module(s) arranged to be connected to the heavy-duty vehicle.

The invention can be applied in heavy-duty vehicles, such as trucks, buses and construction equipment. Although the invention may be described with respect to a truck, the invention is not restricted to this particular vehicle, but may also be used in other vehicles such as buses, trailers, wheel loaders, articulated haulers, excavators, backhoe loaders, passenger cars, marine vessels etc. It may also be applied in various industrial construction machines or working machines. It is applicable in fully electrically operated vehicles as well as in hybrid vehicles, comprising also a combustion engine, and in vehicles only operated by a combustion engine, i.e., not having any electrical engine. The term vehicle may be used herein when referring to any of the above types of vehicles.

### BACKGROUND

Vehicle communication is a field of technology that is constantly developing. It is an increased need for communication and transfer of data and information for example internally within a vehicle, between a towing truck and a connected trailer, between multiple vehicles in a fleet etc. Information security is also important in such communication.

Today, vehicles communicate over a Controller Area Network (CAN) with various add-on modules which offer limited functionality and flexibility. An add-on module may be for example a superstructure, trailer, accessories, equipment etc., and a vehicle, e.g., a truck or a towing truck may be arranged to be connected to one more such add-on modules. A superstructure may be for example a concrete pump, a bucket, a device mounted on the vehicle's chassis to carry load or support work to be done etc.

However, there is a need to improve communication between a heavy-duty vehicle and one or more add-on modules.

### SUMMARY

An object of the invention is to obviate at least one of the above disadvantages and enable improved communication between a main controller of a heavy-duty vehicle and one or more add-on module(s) arranged to be connected to the heavy-duty vehicle.

According to a first aspect, the object is achieved by a vehicle communication system according to claim 1. The vehicle communication system is for enabling communication between a main controller of a heavy-duty vehicle and one or more add-on module(s) arranged to be connected to the heavy-duty vehicle. The vehicle communication system comprises a logical network segment arranged for communication between each add-on module and the main controller thereby enabling each add-on module to communicate with the main controller over a separate logical network segment.

By the provision of a logical network segment for communication between each add-on module and the main controller of the heavy-duty vehicle, the advantage of enabling each add-on module to communicate with the main controller over a separate logical network segment is provided. Provisioning the logical network segment enables a secure connection between each add-on module and the main controller.

Optionally, the main controller may be arranged to communicate with the one or more add-on module(s) via an Application Program Interface (API). An advantage of the API is to give access to data in an interface in a defined, secure and controlled way. An API abstracts the inner workings of a system to a standard, publishable interface that can easily be developed towards and integrated by add-on modules from multiple vendors. The communication may be bi-directional, i.e., the main controller and the add on module may communicate with one another via the API.

Optionally, the vehicle communication system may comprise an in-vehicle application controller arranged to directly communicate with the one or more add-on modules via the respective logical network segment. An advantage of using having an in-vehicle application controller may be that applications can be hosted and run in a secure way in their own “sandbox” without them knowing about or interfere with each other. The in-vehicle app controller may allow users to interface with add-on modules without any need for installation of add-on module vendor specific systems. The in-vehicle application controller may be arranged to host applications from multiple vendors.

Optionally, each logical network segment may be a wired communication link or a wireless communication link. An advantage of a wired communication link may be that it enables fast communication, it is reliable, stable and secure. An advantage of a wireless communication link may be that it enables mobility, installation costs are low, it does not require much hardware.

Optionally, the communication that the logical network segment is arranged for may comprise vehicle data arranged for controlling one or more vehicle functions. An advantage of this may be that vehicle data arranged for controlling one or more vehicle functions are sent via a secure connection between each add-on module and the main controller. This reduces the risk for unauthorized use of the vehicle data, it reduces the risk for unauthorized modification of the vehicle data. Vehicle data arranged for controlling one or more vehicle functions may be associated driving safety, and the driving safety is increased when the vehicle data may be sent via a secure connection.

According to a second aspect, the object is achieved by a method according to claim 6. The method is performed by a control unit and is for enabling communication between a main controller of a heavy-duty vehicle and one or more add-on module(s) arranged to be connected to the heavy-duty vehicle. The control unit initiates setup of a separate logical network segment between each add-on module and the main controller, thereby enabling each add-on module to communicate with the main controller over a separate logical network segment. Advantages and effects of the second aspect of the invention are similar to the advantages and effects with respect to the first aspect of the invention. It shall also be noted that all embodiments of the first aspect of the invention are applicable to and combinable with all embodiments of the second aspect of the invention and vice versa.

Optionally, the communication between each add-on module and the main controller may go via an API.

Optionally, an in-vehicle app controller may communicate directly to the one or more add-on modules via the respective logical network segment.

Optionally, each logical network segment may be a wired communication link or a wireless communication link. An advantage of a wired communication link may be that it enables fast communication, it is reliable, stable and secure. An advantage of a wireless communication link may be that it enables mobility, installation costs are low, it does not require much hardware.

Optionally, the communication between each add-on module and the main controller via the respective logical network segment may comprise vehicle data arranged for controlling one or more vehicle functions. An advantage of this may be that vehicle data arranged for controlling one or more vehicle functions are sent via a secure connection between each add-on module and the main controller. This reduces the risk for unauthorized use of the vehicle data, it reduces the risk for unauthorized modification of the vehicle data. Vehicle data arranged for controlling one or more vehicle functions may be associated driving safety, and the driving safety is increased when the vehicle data may be sent via a secure connection.

According to a third aspect, the object is achieved by a control unit according to claim 11. The control unit is for enabling communication between a main controller of a heavy-duty vehicle and one or more add-on module(s) arranged to be connected to the heavy-duty vehicle. The control unit is arranged to perform the method of the second aspect. The control unit may be an electronic control unit comprising processing circuitry for performing the method of the second aspect. The control unit may be a computer. The control unit may comprise hardware and/or software. Advantages and effects of the third aspect of the invention are similar to the advantages and effects with respect to the first aspect and/or the second aspect of the invention. It shall also be noted that all embodiments of the first aspect and/or the second aspect of the invention are applicable to and combinable with all embodiments of the third aspect of the invention and vice versa.

According to a fourth aspect, the object is achieved by a heavy-duty vehicle according to claim 12. The heavy-duty vehicle comprises a main controller, the vehicle communication system of any of the first aspect and the control unit of the third aspect. Advantages and effects of the fourth aspect of the invention are similar to the advantages and effects with respect to the first aspect and/or the second aspect and/or the third aspect of the invention. It shall also be noted that all embodiments of the first aspect and/or the second aspect and/or the third aspect of the invention are applicable to and combinable with all embodiments of the fourth aspect of the invention and vice versa.

Optionally, one or more add-on module(s) may be connected to the heavy-duty vehicle.

According to a fifth aspect, the object is achieved by a computer program according to claim 14. The computer program comprises program code means for performing the method of the second aspect when the computer program is run on a computer, e.g., the control unit. Advantages and effects of the fifth aspect of the invention are similar to the advantages and effects with respect to the first aspect and/or the second aspect and/or the third aspect and/or the fourth aspect of the invention. It shall also be noted that all embodiments of the first aspect and/or the second aspect and/or the third aspect and/or the fourth aspect of the invention are applicable to and combinable with all embodiments of the fifth aspect of the invention and vice versa.

According to a sixth aspect, the object is achieved by a computer readable medium according to claim 15. The computer readable medium carries a computer program comprising program code means for performing the method of the second aspect when the computer program is run on a computer, e.g., the control unit. Advantages and effects of the sixth aspect of the invention are similar to the advantages and effects with respect to the first aspect and/or the second aspect and/or the third aspect and/or the fourth aspect and/or the fifth aspect of the invention. It shall also be noted that all embodiments of the first aspect and/or the second aspect and/or the third aspect and/or the fourth aspect and/or the fifth aspect of the invention are applicable to and combinable with all embodiments of the sixth aspect of the invention and vice versa.

The present disclosure is not limited to the features and advantages mentioned above. A person skilled in the art will recognize additional features and advantages upon reading the following detailed description.

### BRIEF DESCRIPTION OF THE DRAWINGS

The present disclosure will now be described in more detail by way of example only in the following detailed description by reference to the appended drawings in which:

FIG. 1 is a schematic drawing illustrating a heavy-duty vehicle.

FIG. 2 is a schematic drawing illustrating a vehicle communication system.

FIG. 3 is a flow chart illustrating a method.

FIG. 4A is a schematic drawing illustrating a control unit.

FIG. 4B is a schematic drawing illustrating a control unit.

The drawings are not necessarily to scale, and the dimensions of certain features may have been exaggerated for the sake of clarity. Emphasis is instead placed upon illustrating the principle.

### DETAILED DESCRIPTION

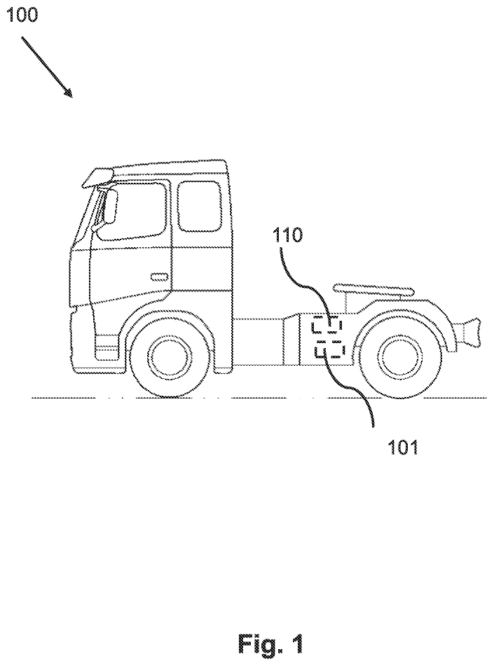

FIG. 1 is a schematic drawing illustrating a heavy-duty vehicle 100. The heavy-duty vehicle 100 may be for example a truck, buss and construction equipment. Although the invention may be described with respect to a truck, the invention is not restricted to this particular vehicle, but may also be used in other vehicles such as buses, trailers, wheel loaders, articulated haulers, excavators, backhoe loaders, passenger cars, marine vessels etc. It may also be applied in various industrial construction machines or working machines. It is applicable in fully electrically operated vehicles as well as in hybrid vehicles, comprising also a combustion engine, and in vehicles only operated by a combustion engine, i.e., not having any electrical engine. The term vehicle together with the reference number 100 may be used herein when referring to any of the above types of vehicles. The vehicle 100 comprises a main controller 101. The main controller 101 may located at any suitable location in the vehicle 100. The main controller 101 is arranged control various functions and units comprised in the vehicle 100 such as engine control, ECU control. A telematics gateway (TGW) may be the host for the API server. The main controller 101 is arranged to communicate via a wireless and/or wired communication link with other controllers and units comprised in the vehicle 100 and with controllers and units external to the vehicle 100.

The vehicle 100 comprises a control unit 110. The control unit 110 is arranged to enable communication between a main controller (101) of a heavy-duty vehicle (100) and one or more add-on module(s) arranged to be connected to the vehicle 100. The control unit 110 may be located at any suitable location in the vehicle 100. The control unit 110 may be located at the same location as the main controller 101, close to the main controller 101 or at a different location compared to the main controller 101. The control unit 110 may be a separate and standalone unit which is separate from the main controller 101, it may be co-located with the main controller 101, or it may be the same as the main controller 101. The control unit 110 is arranged to communicate via a wireless and/or wired communication link with other controllers and units comprised in the vehicle 100, e.g., the main controller 101, and with controllers and units external to the vehicle 100.

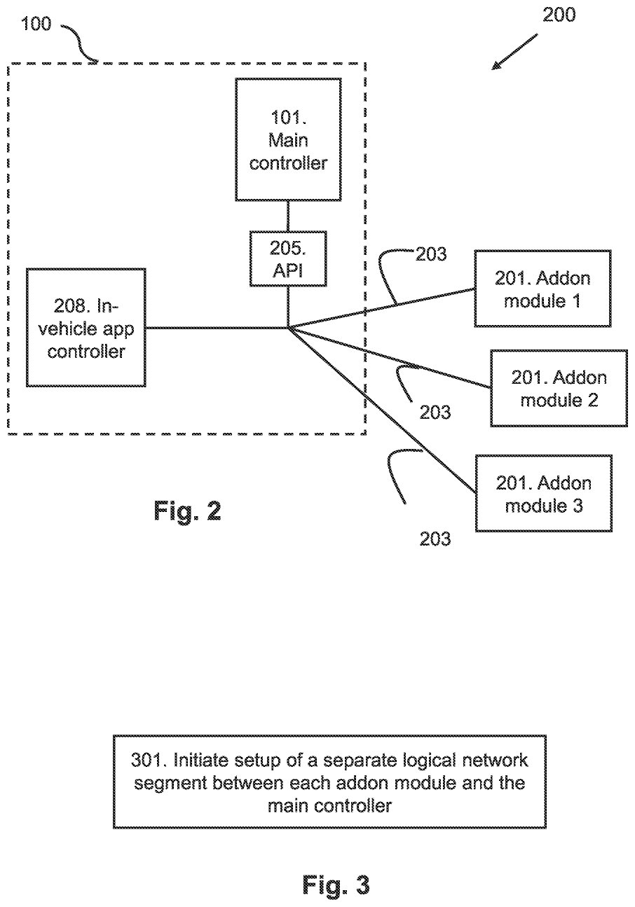

FIG. 2 is a schematic drawing illustrating a vehicle communication system 200. As seen in FIG. 2, the main controller 101 is comprised in the vehicle communication system 200. One or more add-on modules 201 are comprised in the vehicle communication system 200. Three add-on modules 201 are exemplified in FIG. 2, but any n number of add-on modules 201 may be comprised in the vehicle communication system 200, where n is a positive integer. The one or more add-on modules 201 may be comprised in the vehicle 100 or they may be arranged to be connected to the vehicle 100. The one or more add-on modules 201 may be for example a superstructure, e.g., body, a trailer, a vehicle accessory, vehicle equipment, sensor or sensor gateway etc. A superstructure may be for example a concrete pump, a bucket, a device mounted on the vehicle's chassis to carry load or support work to be done etc.

Each add-on module 203 are arranged to be connected to the vehicle 100 via a respective logical network segment 203, i.e., there is one logical network segment 203 per add-on module 203. The one or more add-on modules 203 may be arranged to be connected to the main controller 101 of the vehicle 100 via their respective logical network segment 203. The logical network segment 203 is arranged for communication between each add-on module 201 and the main controller 101 and thereby enabling each add-on module 201 to communicate with the main controller 101 over a separate logical network segment 203, e.g., secure IP communication. The communication that the logical network segment 203 is arranged for may comprise vehicle data arranged for controlling one or more vehicle functions such as for example controlling engine revolutions, turning a power take-off, PTO, system, controlling vehicle motion, controlling vehicle suspension, control of vehicle accessories and control of climate, etc.

The logical network segment 203 may be a container or comprised in a container. A container may be described as a software, a computer program, a computing unit etc. It may be described as an isolated process that are isolated from other processes but still running on the same kernel. With a container, an individual application may be segregated from a host operating system's other process. Rather than running an entire operating system as in a Virtual Machine (VM), a container implements only those interfaces required by the application running in the container. The container may be implemented using a Linux namespace. The container provides a logical structure configured to isolate communication related to one particular add-on module 201 from at least one other form of communication by the vehicle 100, towards the networking capabilities or network segmentations of containers at a logical link layer in relation to external communications. An advantage of using the container is that it implements only those interfaces required by the service running in the container rather than running the entire operating system. Another advantage may be that the quality and speed for enabling the service on the vehicle may be improved. The container may be a docker container. The container may be implemented using a Linux namespace. A Linux namespace is adaptable to several or any type of service that is requested to be provided on the vehicle. Linux namespaces are easy to implement and may be tailormade to a particular service, if necessary.

When the vehicle communication system 200 comprises multiple logical network segment 203, i.e., when there are more than add-on modules 203, the logical network segments 203 may be described as a logical communication network or a virtual communication network. The logical network segment 203 may be a communication link. Each logical network segment 203 may be a wired communication link or a wireless communication link. The logical network segment 203 may be based on any suitable technology such as for example Virtual Local Area Network (VLAN), Wi-Fi SSIDs, IPSEC SAs, BLE Generic Access Profiles etc.

Each add-on module 203 may be arranged to be connected to the main controller 101 of the vehicle 100 via their respective logical network segment 203 and via an API 205. The API 205 may be common to all add-on module 203, i.e., there may be one API 205 that is common for all add-on modules 201. Access to individual APIs may be granted by the system. The main controller 101 is arranged to communicate with the one or more add-on module(s) 201 via the API 205. Using other words, the main controller 101 is arranged to communicate with the logical network via the API 205, where the logical network comprises the logical network segments 203. The API 205 may be an interface, e.g., comprising a firewall function, to the vehicle 100 and enables the communication between the add-on modules 201 and the vehicle 100 to be secure. Communication between connected add-on modules 201 alien to the vehicle 100 are using the logical network. The API 205 may be comprised in a controller which may or may not comprise user facing applications.

In the vehicle communication system 200, there may be an in-vehicle application (app) controller 208 arranged to directly communicate with the one or more add-on modules 201 via the respective logical network segment 203. Directly connected may be described as being connected without going via any other unit before reaching the in-vehicle app controller 208. The in-vehicle app controller 208 may be common to all add-on modules 201, i.e., there may be on in-vehicle app controller 208 that is common for all add-on modules 201. The in-vehicle app controller 208 is arranged to communicate with the one or more add-on modules 201 directly over the logical network segment 203 and not via the API 205. The in-vehicle app controller 208 comprises or is arranged to be connected one or more applications (apps) that are accessible by the user of the vehicle 100, e.g., a driver. The one or more apps may be accessible by the user of the vehicle 100 via any suitable output unit, e.g., a display. The output unit may be comprised an infotainment system of the vehicle 100, a head-up display, a User Equipment (UE) such as a mobile phone, tablet computer etc. Each app that is accessible by the user of the vehicle 100 may be associated with one or more add-on modules 203, i.e., there may be one or more apps per add-on module 203. The app may be in one container and the API 205 may be made available to that container. The API 205 may be described as a resource that may be arranged to be made available to the app in its container. An app and the API 205 are on the same logical network segment 203 as the associated add-on module 203. FIG. 2 shows an example with one in-vehicle app controller 208, but the vehicle 100 may comprise any suitable number of in-vehicle app controllers 208.

The vehicle communication network 200 may comprise one or more network switches (not shown in FIG. 2) in the connection between add-on modules 201. The one or more network switches may represent the physical layer of the vehicle communication network 200.

The method for enabling communication between a main controller 101 of a heavy-duty vehicle 100 and one or more add-on module(s) 201 arranged to be connected to the heavy-duty vehicle 100 will now be described with reference to the flowchart in FIG. 3. The method is performed by a control unit 110 and comprises at least one of the following steps, which steps may as well be carried out in another suitable order than described below:

### Step 301

The control unit 110 initiates setup of a separate logical network segment 203 between each add-on module 201 and the main controller 101, thereby enabling each add-on module 201 to communicate with the main controller 101 over a separate logical network segment 203.

The setup of the separate logical network segment 203 may be triggered by an offboard configuration command, or by detection of attached hardware with a certain network configuration, or by communication with the main controller 101 by a vendor application, or by manual configuration of the vehicle 100 using parameters from an attached tool etc.

After the setup of the separate logical network segment 203, the communication between each add-on module 201 and the main controller 101 may go via an API 205.

An in-vehicle app controller 208 may communicate directly to the one or more add-on modules 201 via the respective logical network segment 203.

Each logical network segment 203 may be a wired communication link or a wireless communication link.

The communication between each add-on module 201 and the main controller 101 via the respective logical network segment 203 may comprise vehicle data arranged for controlling one or more vehicle functions.

Each logical network segment 203 may exist until the add-on module 201 is physically disconnected from the vehicle 100 or until a configuration changes.

In addition to the separate logical network segment 203 between each add-on module 201 and the main controller 101 of the vehicle 100, there may be a physical connection between the add-on module 201 and the vehicle 100, e.g., the trailer is physically connected to the towing truck. The physical connection may be wired or wireless, e.g., Bluetooth, Wi-Fi etc.

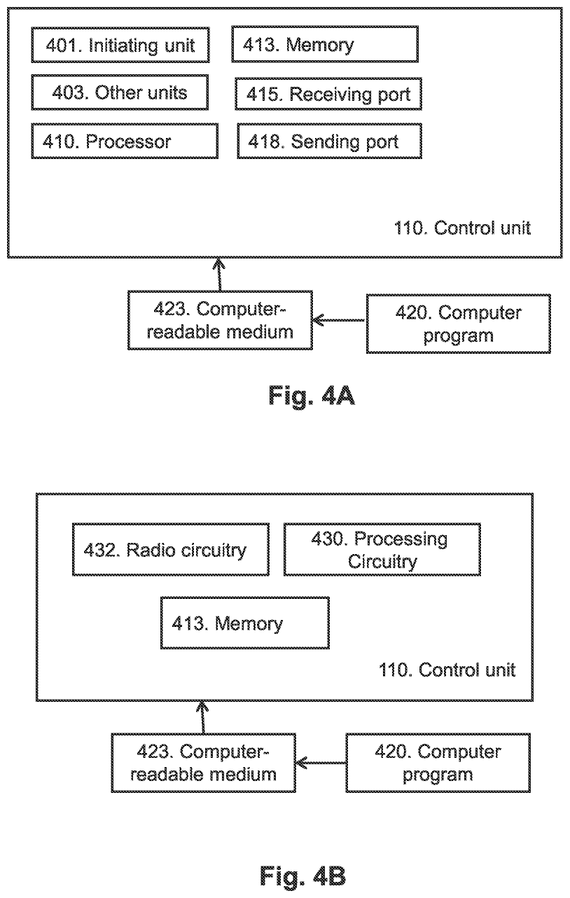

The control unit 110 is arranged to perform the method described herein. To perform the method step shown in FIG. 2 for enabling communication between a main controller 101 of a heavy-duty vehicle 100 and one or more add-on module(s) 201 arranged to be connected to the heavy-duty vehicle 100, the control unit 101 may comprises an arrangement as shown in FIG. 4A and/or FIG. 4B. FIG. 4A and FIG. 4B depict two different examples in panels a) and b), respectively, of the arrangement that the control unit 110 may comprise. The control unit 110 may comprise the following arrangement depicted in FIG. 4A.

The control unit 110 is arranged to, e.g., by means of an initiating unit 401, initiate setup of a separate logical network segment 203 between each add-on module 201 and the main controller 101, thereby enabling each add-on module 201 to communicate with the main controller 101 over a separate logical network segment 203.

The communication between each add-on module 201 and the main controller 101 may go via an API 205.

An in-vehicle app controller 208 may communicate directly to the one or more add-on modules 201 via the respective logical network segment 203.

Each logical network segment 203 may be a wired communication link or a wireless communication link.

The communication between each add-on module 201 and the main controller 101 via the respective logical network segment 203 may comprise vehicle data arranged for controlling one or more vehicle functions.

The present disclosure related to the control unit 110 may be implemented through one or more processors, such as a processor 410 in the control unit 110 depicted in FIG. 4A, together with computer program code for performing the functions and actions described herein. A processor, as used herein, may be understood to be a hardware component. The program code mentioned above may also be provided as a computer program product, for instance in the form of a data carrier carrying computer program code for performing the present disclosure when being loaded into the control unit 110. One such carrier may be in the form of a CD ROM disc. It is however feasible with other data carriers such as a memory stick. The computer program code may be provided as pure program code on a server and downloaded to the control unit 110.

The control unit 110 may comprise a memory 413 comprising one or more memory units. The memory 413 is arranged to be used to store obtained information, store data, configurations, schedulings, and applications etc. to perform the methods herein when being executed in the control unit 110.

The control unit 110 may receive information from, e.g., the main controller 101, one or more add-on modules 203, through a receiving port 415. The receiving port 415 may be, for example, connected to one or more antennas in control unit 110. The control unit 110 may receive information from another structure in the vehicle communications system 200 through the receiving port 415. Since the receiving port 415 may be in communication with the processor 410, the receiving port 415 may then send the received information to the processor 410. The receiving port 415 may also be configured to receive other information.

The processor 410 in the control unit 110 may be configured to transmit or send information to e.g., main controller 101, one or more add-on modules 201 or another structure in the vehicle communications system 100, through a sending port 418, which may be in communication with the processor 410, and the memory 413.

The UE 105 may comprise the initiating unit 401, other unit(s) 403 etc.

Those skilled in the art will also appreciate that the initiating unit 401, other unit(s) 403 etc. described above may refer to a combination of analogue and digital circuits, and/or one or more processors configured with software and/or firmware, e.g., stored in memory, that, when executed by the one or more processors such as the processor 410, perform as described above. One or more of these processors, as well as the other digital hardware, may be comprised in a single Application-Specific Integrated Circuit (ASIC), or several processors and various digital hardware may be distributed among several separate components, whether individually packaged or assembled into a System-on-a-Chip (SoC).

The different units 401-403 described above may be implemented as one or more applications running on one or more processors such as the processor 410.

Thus, the methods described herein for the control unit 110 may be respectively implemented by means of a computer program 420 product, comprising instructions, i.e., software code portions, which, when executed on at least one processor 1001, cause the at least one processor 410 to carry out the actions described herein, as performed by the control unit 110. The computer program 420 product may be stored on a computer-readable storage medium 423. The computer-readable storage medium 423, having stored thereon the computer program 420, may comprise instructions which, when executed on at least one processor 410, cause the at least one processor 410 to carry out the actions described herein, as performed by the control unit 110. The computer-readable storage medium 423 may be a non-transitory computer-readable storage medium, such as a CD ROM disc, or a memory stick. The computer program 420 product may be stored on a carrier containing the computer program 420 just described, wherein the carrier is one of an electronic signal, optical signal, radio signal, or the first computer-readable storage medium 423, as described above.

The control unit 110 may comprise a communication interface configured to facilitate communications between the control unit 110 and other nodes or devices, e.g., the main controller 101, one or more add-on modules 201, or another structure. The interface may comprise a transceiver configured to transmit and receive radio signals over an air interface in accordance with a suitable standard.

The control unit 110 may comprise the following arrangement depicted in FIG. 4B. The control unit 110 may comprise a processing circuitry 430, e.g., one or more processors such as the processor 410, in the control unit 110 and the memory 413. The control unit 110 may also comprise a radio circuitry 432, which may comprise e.g., the receiving port 415 and the sending port 418. The processing circuitry 430 may be configured to, or operable to, perform the method actions according to FIG. 3, in a similar manner as that described in relation to FIG. 4A. The radio circuitry 432 may be configured to set up and maintain at least a wireless connection with the control unit 110. Circuitry may be understood herein as a hardware component.

Hence, the present disclosure also relates to the control unit 110 operative to operate in the vehicle communications system 200. The control unit 110 may comprise the processing circuitry 430 and the memory 413. The memory 413 comprises instructions executable by the processing circuitry 430. The control unit 110 is operative to perform the actions described herein in relation to the control unit 110, e.g., in FIG. 3.

Summarized, in the vehicle communication system 200 the one or more add-on modules 201 are connected to the vehicle 100 in a virtual communication network using the logical network segments 201, wired or wirelessly, to isolate it from the rest of the vehicle 100. Vehicle data and functions that will affect the vehicle 100, like controlling engine revolutions, PTO On/Off etc., may be made available over an API 205 that is secure and access controlled.

The logical network segments 201 may also be connected directly into the in-vehicle app controller 208 to offer flexibility in solutions.

With the logical network segments 201, 3rd parties associated with the add-on modules 201 will be able to customize their solution with secure connection to vehicle data, driver interaction via in-vehicle android apps and cloud connections over internet.

The logical network segment 203 is arranged for communication between each add-on module 201 and the main controller 101 and thereby enabling each add-on module 201 to communicate with the main controller 101 over a separate logical network segment 203, e.g., secure IP communication.

In general, the usage of “first”, “second”, “third”, “fourth”, and/or “fifth” herein may be understood to be an arbitrary way to denote different elements or entities and may be understood to not confer a cumulative or chronological character to the nouns they modify, unless otherwise noted, based on context.

The present disclosure is not limited to the above. Various alternatives, modifications and equivalents may be used. Therefore, disclosure herein should not be taken as limiting the scope. A feature may be combined with one or more other features.

The term “at least one of A and B” should be understood to mean “only A, only B, or both A and B”, where A and B are any parameter, number, indication used herein etc.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

The term “configured to” used herein may also be referred to as “arranged to”, “adapted to”, “capable of” or “operative to”.

The steps of the methods may be performed in another order than the order in which they appear herein.

1. A vehicle communication system for enabling communication between a main controller of a heavy-duty vehicle and one or more add-on module(s) arranged to be connected to the heavy-duty vehicle, the vehicle communication system comprising:
a logical network segment arranged for communication between each add-on module and the main controller, thereby enabling each add-on module to communicate with the main controller over a separate logical network segment.

2. The vehicle communication system of claim 1, wherein the main controller is arranged to communicate with the one or more add-on module(s) via an Application Program Interface (API).

3. The vehicle communication system of claim 1, comprising an in-vehicle application controller arranged to directly communicate with the one or more add-on module(s) via the respective logical network segment.

4. The vehicle communication system of claim 1, wherein each logical network segment is a wired communication link or a wireless communication link.

5. The vehicle communication system of claim 1, wherein the communication that the logical network segment is arranged for comprises vehicle data arranged for controlling one or more vehicle functions.

6. A method performed by a control unit for enabling communication between a main controller of a heavy-duty vehicle and one or more add-on module(s) arranged to be connected to the heavy-duty vehicle, the method comprising:
initiating setup of a separate logical network segment between each add-on module and the main controller, thereby enabling each add-on module to communicate with the main controller over a separate logical network segment.

7. The method of claim 6, wherein the communication between each add-on module and the main controller goes via an Application Program Interface (API).

8. The method of claim 6, wherein an in-vehicle app controller communicates directly to the one or more add-on module(s) via the respective logical network segment.

9. The method of claim 6, wherein each logical network segment is a wired communication link or a wireless communication link.

10. The method of claim 6, wherein the communication between each add-on module and the main controller via the respective logical network segment comprises vehicle data arranged for controlling one or more vehicle functions.

11. A control unit for enabling communication between a main controller of a heavy-duty vehicle and one or more add-on module(s) arranged to be connected to the heavy-duty vehicle, the control unit being arranged to perform the method of claim 6.

12. A heavy-duty vehicle comprising:
a main controller;
a vehicle communication system for enabling communication between the main controller and one or more add-on module(s) arranged to be connected to the heavy-duty vehicle, the vehicle communication system comprising:
a logical network segment arranged for communication between each add-on module and the main controller, thereby enabling each add-on module to communicate with the main controller over a separate logical network segment; and
the control unit of claim 11.

13. The heavy-duty vehicle of claim 12, wherein the one or more add-on module(s) are connected to the heavy-duty vehicle.

14. A computer program comprising program code means for performing the steps of claim 6 when the computer program is run on a computer.

15. A computer readable medium carrying a computer program comprising program code means for performing the steps of claim 6 when the computer program is run on a computer.
